(19) United States
(12) Patent Application Publication
(10) Pub. No.: US 2012/0210237 A1
(43) Pub. Date: Aug. 16, 2012

(54) Recording A Trail Of Webpages

(75) Inventors: Troy L. Coleman, Palatine, IL (US); Michael S. Cetaruk, Austin, TX (US); Patrick A. Dickinson, Brooklyn, NY (US); Misty A. Cripps, Austin, TX (US)

(73) Assignee: COMPUTER ASSOCIATES THINK, INC., Islandia, NY (US)

(21) Appl. No.: 13/028,573

(22) Filed: Feb. 16, 2011

(51) Int. Cl. G06F 3/01; G06F 15/16

(52) U.S. Cl. 715/738

(57) ABSTRACT

According to certain embodiments, recording a trail of webpages includes repeating the following to yield steps of a trail: saving content of a webpage as historical content of the webpage in a step, and saving one or more parameters of the webpage in the step. The parameters comprise a location parameter of the webpage. Display of a trail overview comprising step selectors is initiated. Each step selector corresponds to a step and is configured to initiate display of the historical content of the webpage of the step corresponding to the step selector.

### TECHNICAL FIELD

This invention relates generally to the field of web browsing and more specifically to recording a trail of webpages.

### BACKGROUND

A web browser may obtain and render a number of different webpages. In certain circumstances, the trail of the webpages may be recorded. The trail may be used to obtain and render the webpages again.

### SUMMARY OF THE DISCLOSURE

In accordance with the present invention, disadvantages and problems associated with previous techniques for recording the trail of webpages may be reduced or eliminated.

According to certain embodiments, recording a trail of webpages includes repeating the following to yield steps of a trail: saving content of a webpage as historical content of the webpage in a step, and saving one or more parameters of the webpage in the step. The parameters comprise a location parameter of the webpage. Display of a trail overview comprising step selectors is initiated. Each step selector corresponds to a step and is configured to initiate display of the historical content of the webpage of the step corresponding to the step selector.

Certain embodiments of the invention may provide one or more technical advantages. A technical advantage of one embodiment may be that the historical content of a rendered webpage is saved such that the historical content can be displayed again. Another technical advantage of one embodiment may be that a refresh button may be selected when historical content of a webpage is displayed in order to display current content of the webpage. Another technical advantage of one embodiment may be that a webpage trail may include steps representing webpages. The trail may be edited to add a step, remove a step, and/or modify a step. In addition, comments may be added to the steps of a trail.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an example of a system that includes a trail manager that records webpage trails;

FIG. 2 illustrates an example of a screenshot that may be used to display content of a webpage;

FIG. 3 illustrates an example of a method for recording a webpage trail;

FIG. 4 illustrates an example of a method for editing a webpage trail; and

FIG. 5 illustrates an example of a method for requesting current content of a webpage.

### DETAILED DESCRIPTION OF THE DRAWINGS

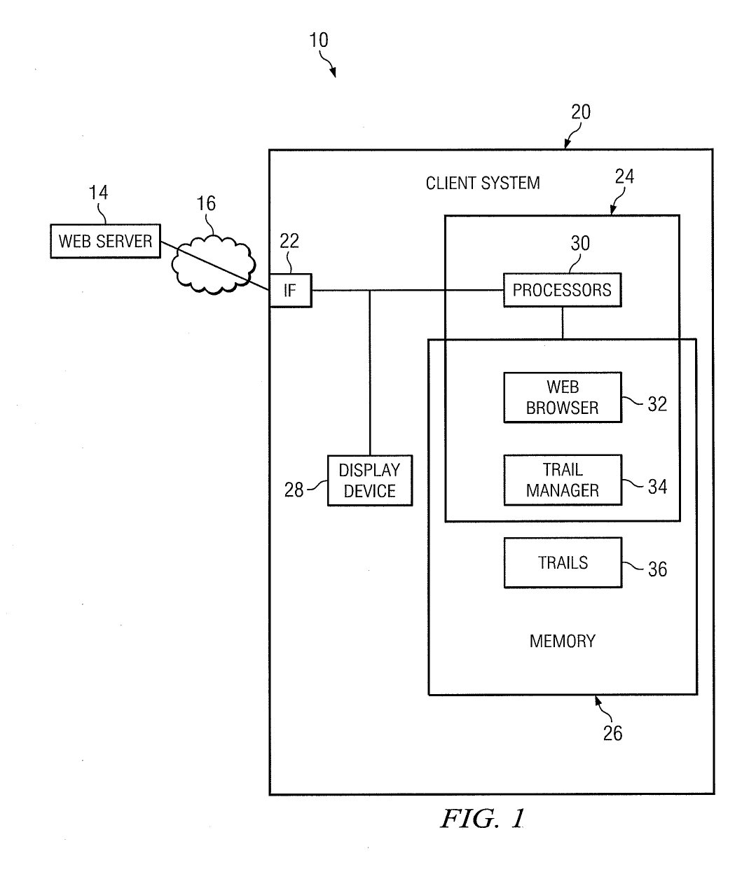

Embodiments of the present invention and its advantages are best understood by referring to FIGS. 1 through 5 of the drawings, like numerals being used for like and corresponding parts of the various drawings.

FIG. 1 illustrates an example of a system 10 that includes a trail manager 34 that records webpage trails. In certain embodiments, trail manager 34 saves historical content of a rendered webpage such that the historical content can be rendered again. In certain embodiments, trail manager 34 may initiate display of a refresh button when historical content of a webpage is rendered. The refresh button may be selected in order to display current content of the webpage. In certain embodiments, trail manager 34 may generate a webpage trail that includes steps representing webpages. Trail manager 34 may allow for the trail to be edited to add a step, remove a step, and/or modify a step. In addition, trail manager 34 may allow for adding comments to the steps of a trail.

In the illustrated example, system 10 includes a web server 14 and a client system 20. Client system 20 includes an interface (IF) 22, logic 24, one or more memories 26, and a display device 28. Logic 24 includes one or more processors 30, an application such as a web browser 32, and a trail manager 34. Memory 26 stores information used by client system 20 such as applications and trails 36.

Web server 14 delivers webpages over a communication network 16. Web server 14 may include a computer program and/or a computer system to deliver web pages. Web browser 32 retrieves and/or renders (or presents) webpages.

A webpage is used to communicate content from web server 14 to web browser 32 for rendering at display device 28. A webpage may be formatted according to any suitable webpage markup language, such as HyperText Markup Language (HTML). A webpage may be stored at and/or retrieved from client system 20 or from web server 14. Web browser 32 may request webpages using any suitable networking protocol, such as Hypertext Transfer Protocol (HTTP).

Webpage content may include any suitable information, such as rendered and hidden information. Rendered information may include any suitable information that can be rendered to be seen and/or heard by a user. Examples of rendered information include text, images (static or animated), audio, video, interactive information, selectors (such as buttons), hyperlinks, and forms. Hidden information may include information used to describe, render, and/or obtain rendered information or other content. Examples of hidden information include comments, linked files, metadata, style information, visual specifications, scripts, and address tracking information.

In certain examples of operation, trail manager 43 repeats the following to yield steps of a trail: saves content of a webpage as historical content of the webpage in a step; and saves one or more parameters of the webpage in the step. A parameter may comprise a location parameter of the webpage. In the examples, trail manager 43 initiates display of a trail overview comprising step selectors. Each step selector corresponds to a step and is configured to initiate display of the historical content of the webpage of the step corresponding to the step selector.

In certain examples, trail manager 43 saves content of a webpage as historical content of the webpage in a step. Saving content in a step may refer to mapping the content to the step such that selecting the step may retrieve the content. In certain embodiments, trail manager 43 may save the content of web pages by saving the content for each webpage or by saving the changes in the content among the web pages.

Historical content may be content of webpages that were retrieved in the past. For example, a webpage may be rendered and then content of the webpage may be stored as historical content that may be displayed after the webpage is no longer being rendered. Current content may be content of a webpage that is currently being rendered.

In certain examples, trail manager 43 saves one or more parameters of the webpage in a step. Any suitable parameters, such as location and connectivity parameters, may be saved. A location parameter of a webpage may be used to retrieve the webpage from web server 14. Location parameter may include, for example, a uniform resource identifier (URI). A connectivity parameter of a webpage may allow different client systems 20 to access the webpage.

In certain examples, trail manager 43 generates a trail from the steps. In the examples, trail manager 43 initiates display of a trail overview comprising step selectors. Each step selector corresponds to a step and is configured to be selected to initiate display of the historical content of the webpage of the step corresponding to the step selector.

Display device 28 presents webpages. Examples of display devices 28 include a monitor, a television, a screen, or other display. An application such as trail manager 34 may initiate display of an image such as a webpage on display device 28 by sending information to display device 28 that allows display device 28 to present the webpage.

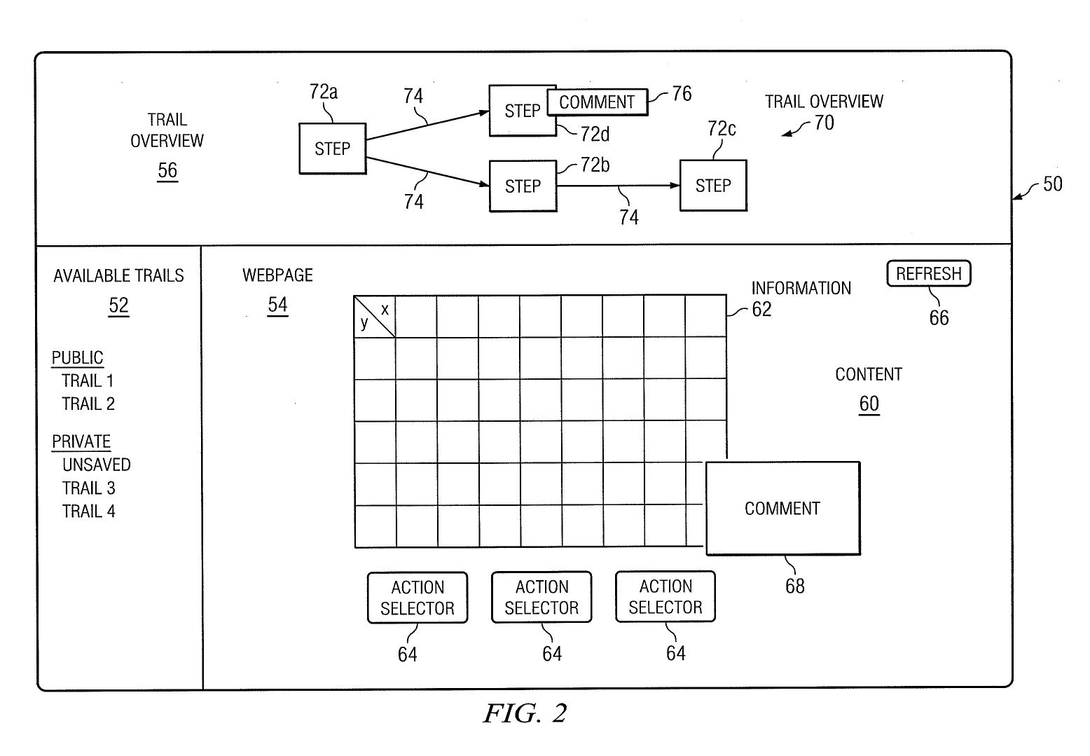

FIG. 2 illustrates an example of a screenshot 50 that may be used to display content of a webpage. In the example, screenshot 50 includes an available trails window 52, a webpage window 54, and a trail overview window 56.

Available trails window 52 presents available trails. Available trails may be, for example, trails that are available to the user logged into client system 20, which may be determined by a user identifier entered into client system 20. In the example, available trails include public and private trails. Public trails may be trails available to a global set of users that includes the logged-in user. The global set of user may include, for example, employees of a company. Private trails may include trails available to only the logged-in user and perhaps one or more other users of a subset of the global set. The private trails may include an unsaved trail that includes the last presented webpages that have not been saved in a trail.

Webpage window 54 displays content 60 (such as historical and/or current content) of webpages, a refresh button 66, and a comment 68. Refresh button 66 may be selected to request current content for a webpage. In certain embodiments, refresh button 66 may be activated when historical and/or current content is displayed. Requesting current content is described in more detail with reference to FIG. 5.

Content 60 may include information 62 and/or one or more action selectors 64. Information 62 may include rendered information as discussed previously. An action selector 64 may be selected in order to activate an action. Examples of actions include save content, edit content, retrieve content, and send content. In certain embodiments, an action selector 64 may be selected if current content is being displayed. If historical content is being displayed, train manager 34 may deactivate action selector 65 to prevent activation of an action. A deactivated action selector 64 may have a visual indicator that indicates deactivation, for example, a different color.

Webpage window 54 may also display a comment 68 added to a rendered webpage. Comment 68 may include text that is entered by a user into the webpage.

Trail overview window 56 includes a trail overview 70 that represents webpages that have been presented. In the example, trail overview 70 includes step selectors 72 connected by arrows 74. A step selector 72 represents a webpage that has been presented and may be selected to present the content of the webpage again. An arrow 74 indicates the order in which the webpages were presented. In the illustrated example, the webpage of step selector 72a (which may be written as webpage 72a) was presented first, then webpage 72b, and then webpage 72c. At some point, webpage 72a was presented again and then webpage 72d was presented. A step selector 72 may have any suitable appearance. In certain examples, step selector 72 may appear as a smaller version of the webpage that it represents.

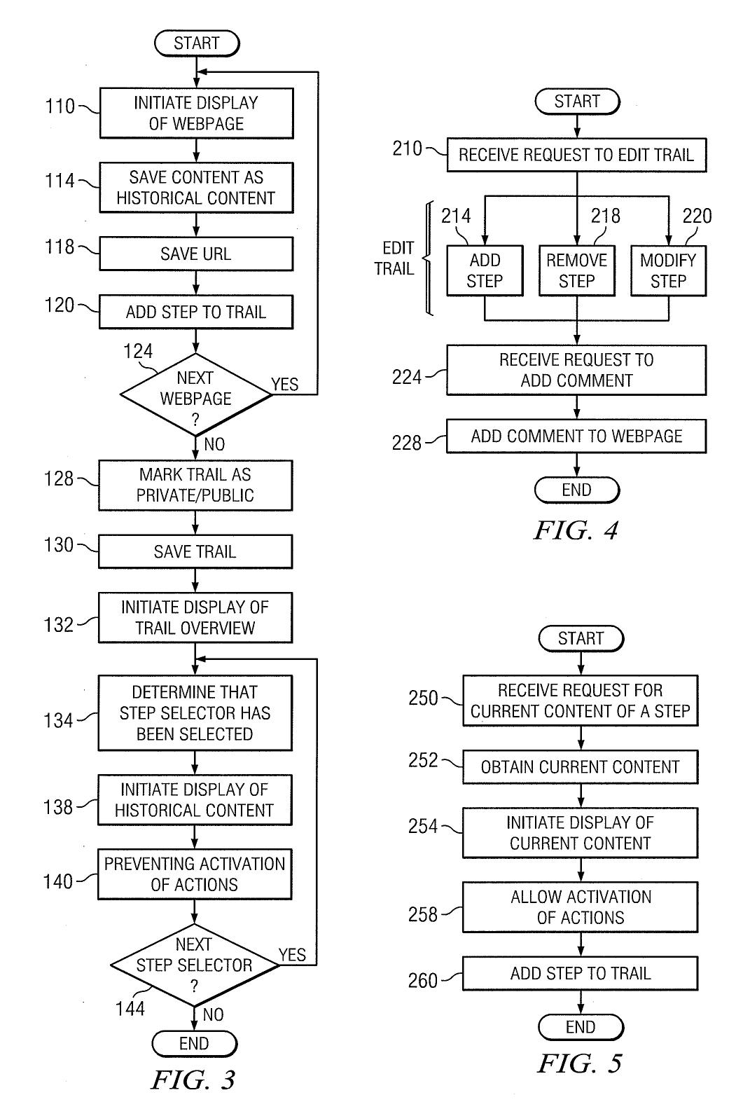

Trail overview 70 includes a comment indicator 76 that indicates that the webpage 72d has a comment 68. Trail overview 70 may be used to retrieve and/or modify a trail and/or webpage. Retrieving a webpage and/or modifying a trail and/or webpage is described in more detail with respect to FIGS. 3 and 4.

FIG. 3 illustrates an example of a method for recording a webpage trail that may be performed by trail manager 32. The method may be performed using screenshot 50.

The method starts at step 110. Steps 110 through 124 are repeated to yield a plurality of steps of a webpage trail. Display of a webpage is initiated at step 110. In certain embodiments, display of a webpage may be initiated in response to a user requesting a webpage and/or web browser 32 obtaining the webpage. In certain embodiments, trail manager 34 may initiate the display by sending information to display device 28 that allows display device 28 to present the webpage.

Content of a webpage is saved as historical content of the webpage in a trail step at step 114. In certain embodiments, the trail step may be generated in response to display of the webpage and then content may be saved in the step. In certain embodiments, content may be saved in a step by mapping the content to the step such that selecting the step retrieves the content. One or more parameters of the webpage are saved in the trail step at step 118. A parameter may be a location parameter of the webpage. A trail step representing the displayed webpage is added to the trail at step 120.

There may be a next webpage to be displayed at step 124. Trail manager 34 may determine if there is a next webpage in any suitable manner. In certain embodiments, trail manager 34 may determine that there is a next webpage if a user requests the next webpage. In certain embodiments, trail manager 34 may determine there is no next webpage if the user indicates that the trail is complete. If there is a next webpage the method returns to step 110 to initiate display of the next webpage. If there is no next webpage, the method proceeds to step 128.

The trail is marked as public or private at step 128. In certain embodiments, the trail may be marked as public (or private) in response to a request from the user to mark the trail as public (or private). The trail is saved at step 130. The trail may be saved in, for example, memory 26.

Display of a trail overview is initiated at step 132. In certain embodiments, the trail overview comprises step selectors. Each step selector is configured to initiate display of the historical content of the webpage of the step corresponding to the step selector.

Selection of a step selector corresponding to a trail step is detected at step 134. In certain embodiments, trail manager 34 detects that the user has selected the step selector. Display of the historical content of the webpage of the trail step is initiated at step 138. In certain embodiments, trail manager 34 may initiate the display by sending information to display device that allows display device to present the historical content. Activation of action selectors of the historical content is prevented at step 140. In certain embodiments, trail manager 34 may deactivate the action selectors.

A next step selector may be selected at step 144. If the next step selector is selected at step 144, the method returns to step 134 where it is determined that the next step selector has been selected. If no next step selector has been selected at step 144, the method ends.

FIG. 4 illustrates an example of a method for editing a webpage trail that may be performed by trail manager 32. The method may be performed using screenshot 50 that displays trail overview 70 representing the webpage trail.

The method starts at step 210. A request to edit a trail step of the trail is received at step 210. In certain embodiments, a step selector may be selected to make the request. The selected step indicator indicates a selected trail step to edit. The request may request to add a step to, remove a step from, or modify a step of the trail.

Steps 214 through 220 illustrate examples of ways to edit the step in response to the request. A step may be added at step 214. For example, the request may be to add a step from another trail to a current trail, either before or after the selected step. As another example, the request may be to add a step copied from one portion of a current trail to another portion of the current trail. A step may be removed at step 218. As an example, the request may be to remove the selected step. A step may be modified at step 220. For example, the request may be to modify a comment 68 of the selected step.

A request to add a comment to a webpage of a trail step of the trail is received at step 224. The comment may include text entered by a user. The comment is added to the webpage in response to the request at step 228. The method then ends.

FIG. 5 illustrates an example of a method for requesting current content of a webpage that may be performed by trail manager 32. The method may be performed using screenshot 50 that displays a trail overview 70 that represents a trail.

The method starts at step 250. A request for current content of a webpage is received at step 250. In certain embodiments, refresh button 66 may be selected to request current content of a webpage. The current content is obtained using the location parameter of the webpage at step 252. In certain embodiments, web browser 32 may request current content from web server 14 using a URI. Display of the current content is initiated at step 254. In certain embodiments, trail manager 34 may initiate the display by sending information to display device that allows display device 28 to present the current content.

Activation of actions is allowed at step 258. In certain embodiments, an action selector 64 may be made active such that selection of action selector 64 may initiate the action represented by action selector 64. The current content is added as historical content in an added trail step that is added to the trail at step 260.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. For example, the operations of trail manager 32 may be performed by more than one component. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

A component of the systems and apparatuses disclosed herein may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Logic may be encoded in one or more tangible media and may perform operations when executed by a computer. Certain logic, such as a processor, may manage the operation of a component. Examples of a processor include one or more computers, one or more microprocessors, one or more applications, and/or other logic.

In particular embodiments, the operations of the embodiments may be performed by one or more computer readable media encoded with a computer program, software, computer executable instructions, and/or instructions capable of being executed by a computer. In particular embodiments, the operations of the embodiments may be performed by one or more computer readable media storing, embodied with, and/or encoded with a computer program and/or having a stored and/or an encoded computer program.

A memory stores information. A memory may comprise one or more non-transitory, tangible, computer-readable, and/or computer-executable storage media. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

Components of the systems and apparatuses may be coupled by any suitable communication network (such as communication network 16). A communication network may comprise all or a portion of one or more of the following: a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of any of the preceding.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method comprising:
repeating the following to yield a plurality of steps of a trail:
saving content of a webpage as historical content of the webpage in a step; and
saving one or more parameters of the webpage in the step, the one or more parameters comprising a location parameter of the webpage; and
initiating display of a trail overview comprising a plurality of step selectors, each step selector corresponding to a step and configured to initiate display of the historical content of the webpage of the step corresponding to the step selector.

2. The method of claim 1, further comprising:
detecting that a step selector corresponding to a step has been selected; and
initiating display of the historical content of the webpage of the step.

3. The method of claim 1, further comprising:
initiating display of historical content of a webpage of a step; and
preventing activation of one or more action selectors of the historical content.

4. The method of claim 1, further comprising:
initiating display of historical content of a webpage of a step;
receiving request for current content of the webpage;
obtaining the current content using the location parameter of the webpage of the step; and
initiating display of the current content.

5. The method of claim 1, further comprising:
initiating display of current content of a webpage of a step; and
adding the current content as historical content in an added step added to the trail.

6. The method of claim 1, further comprising:
receiving a request to edit a step of the trail; and
editing the step in response to the request.

7. The method of claim 1, further comprising:
receiving a request to add a comment to a webpage of a step of the trail; and
adding the comment to the webpage in response to the request.

8. The method of claim 1, further comprising:
receiving a request to mark a trail as public or private; and
marking the trail as requested.

9. An apparatus comprising:
one or more memories configured to save a plurality of steps of a trail; and
one or more processors configured to:
repeat the following to yield a plurality of steps of a trail:
save content of a webpage as historical content of the webpage in a step; and
save one or more parameters of the webpage in the step, the one or more parameters comprising a location parameter of the webpage; and
initiate display of a trail overview comprising a plurality of step selectors, each step selector corresponding to a step and configured to initiate display of the historical content of the webpage of the step corresponding to the step selector.

10. The apparatus of claim 9, the one or more processors configured to:
detect that a step selector corresponding to a step has been selected; and
initiate display of the historical content of the webpage of the step.

11. The apparatus of claim 9, the one or more processors configured to:
initiate display of historical content of a webpage of a step; and
prevent activation of one or more action selectors of the historical content.

12. The apparatus of claim 9, the one or more processors configured to:
initiate display of historical content of a webpage of a step;
receive request for current content of the webpage;
obtain the current content using the location parameter of the webpage of the step; and
initiate display of the current content.

13. The apparatus of claim 9, the one or more processors configured to:
initiate display of current content of a webpage of a step; and
add the current content as historical content in an added step added to the trail.

14. The apparatus of claim 9, the one or more processors configured to:
receive a request to edit a step of the trail; and
edit the step in response to the request.

15. The apparatus of claim 9, the one or more processors configured to:
receive a request to add a comment to a webpage of a step of the trail; and
add the comment to the webpage in response to the request.

16. The apparatus of claim 9, the one or more processors configured to:
receive a request to mark a trail as public or private; and
mark the trail as requested.

17. One or more non-transitory computer-readable media having computer-executable instructions, when executed by a computer operable to:
repeat the following to yield a plurality of steps of a trail:
save content of a webpage as historical content of the webpage in a step; and
save one or more parameters of the webpage in the step, the one or more parameters comprising location parameter of the webpage; and
initiate display of a trail overview comprising a plurality of step selectors, each step selector corresponding to a step and configured to initiate display of the historical content of the webpage of the step corresponding to the step selector.

18. The media of claim 17, configured to:
detect that a step selector corresponding to a step has been selected; and
initiate display of the historical content of the webpage of the step.

19. The media of claim 17, configured to:
initiate display of historical content of a webpage of a step; and
prevent activation of one or more action selectors of the historical content.

20. The media of claim 17, configured to:
initiate display of historical content of a webpage of a step;
receive request for current content of the webpage;
obtain the current content using the location parameter of the webpage of the step; and
initiate display of the current content.

21. The media of claim 17, configured to:
initiate display of current content of a webpage of a step; and
add the current content as historical content in an added step added to the trail.

22. The media of claim 17, configured to:
receive a request to edit a step of the trail; and
edit the step in response to the request.

23. The media of claim 17, configured to:
receive a request to add a comment to a webpage of a step of the trail; and
add the comment to the webpage in response to the request.

24. The media of claim 17, configured to:
receive a request to mark a trail as public or private; and
mark the trail as requested.
